(19) United States
(12) Patent Application Publication
(10) Pub. No.: US 2023/0113146 A1
(43) Pub. Date: Apr. 13, 2023

(54) COMBINED ARCHERY CAP AND ARROW TOOL

(71) Applicant: Schwartz Industries, Inc., Lewisville, TX (US)

(72) Inventor: Eric Ravenna, Lewisville, TX (US)

(21) Appl. No.: 17/498,199

(22) Filed: Oct. 11, 2021

(51) Int. Cl. F41B 5/06; B25B 13/02

(52) U.S. Cl. CPC F41B 5/06; B25B 13/02

(57) ABSTRACT

An archery cap tool is configured to serve as a lid for an arrow storage container as well as a tool for use with arrows. The archery cap tool may contain a broadhead tool as well as a plurality of nock tools in various sizes. The archery cap tool is interchangeable among arrow storage containers, allowing an archer to ensure a desired tool is available.

### TECHNICAL FIELD

The present disclosure relates to archery, and particularly to systems and methods for archery tools.

### BACKGROUND

Archery arrows are typically stored in a tube or quiver, and the tube is often closed or secured via a removable cap to allow arrows to be inserted or removed. More generally, a variety of situations may arise where it is desirable for a tool to be integrated with a storage cap or lid. Accordingly, improved archery tools and storage systems remain desirable.

### SUMMARY

An integrated archery cap and tool, and methods for use of the same are provided. In an exemplary embodiment, an archery cap tool comprises a main body comprising a durable material and having an inner surface, an outer surface, and a top surface; a broadhead wrench tool formed in the main body and comprising an opening in the top surface; and a plurality of nock tools formed in the main body in the top surface.

In another exemplary embodiment, a method comprises forming an archery cap for coupling to an arrow storage container; forming a broadhead tool in the archery cap to form an archery cap tool; and forming a plurality of nock tools in the archery cap tool.

The contents of this summary section are provided only as a simplified introduction to the disclosure and are not intended to be used to limit the scope of the appended claims.

### BRIEF DESCRIPTION OF THE DRAWINGS

With reference to the following description, appended claims, and accompanying drawings:

FIG. 1 illustrates a front perspective view of an archery cap tool in accordance with various exemplary embodiments;

FIG. 2 illustrates a rear perspective view of an archery cap tool in accordance with various exemplary embodiments;

FIG. 3 illustrates another rear perspective view of an archery cap tool in accordance with various exemplary embodiments;

FIG. 4 illustrates a top view of an archery cap tool in accordance with various exemplary embodiments;

FIG. 5A illustrates a top view of an archery cap tool in accordance with various exemplary embodiments;

FIG. 5B illustrates a sectional view of an archery cap tool along line B-B of FIG. 5A in accordance with various exemplary embodiments;

FIG. 6A illustrates a top view of an archery cap tool in accordance with various exemplary embodiments;

FIG. 6B illustrates a broadhead wrench tool of an archery cap tool in accordance with various exemplary embodiments; and

FIGS. 7A and 7B illustrate surfaces of an archery cap tool to demonstrate naming conventions in accordance with various exemplary embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for archery systems, bows, arrows, quivers, storage tubes, tools, construction, repair, adjustment, tuning, and/or the like may not be described in detail herein. Furthermore, the connecting lines shown in various figures contained herein are intended to represent exemplary functional relationships and/or physical couplings between various elements. It should be noted that many alternative or additional functional relationships or physical connections may be present in a integrated archery cap and tool and/or related methods of use.

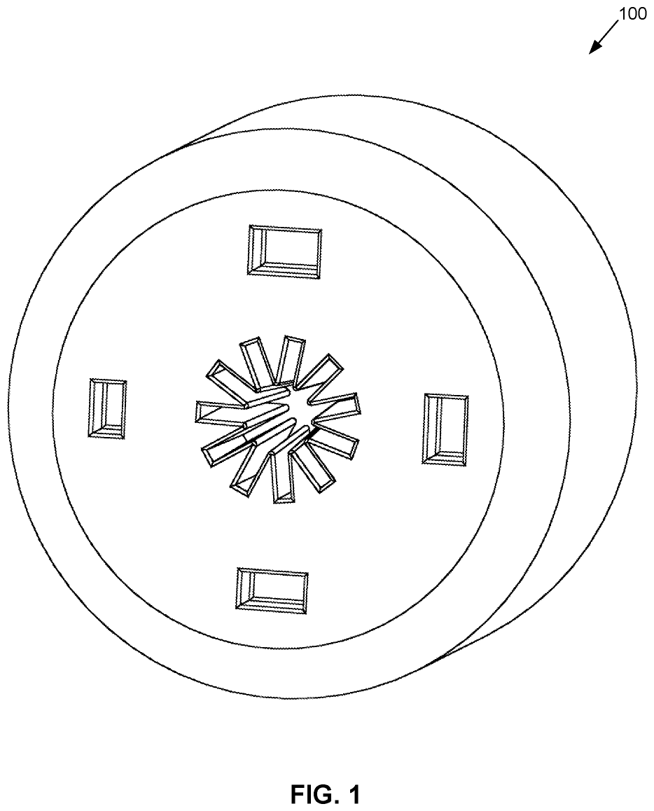

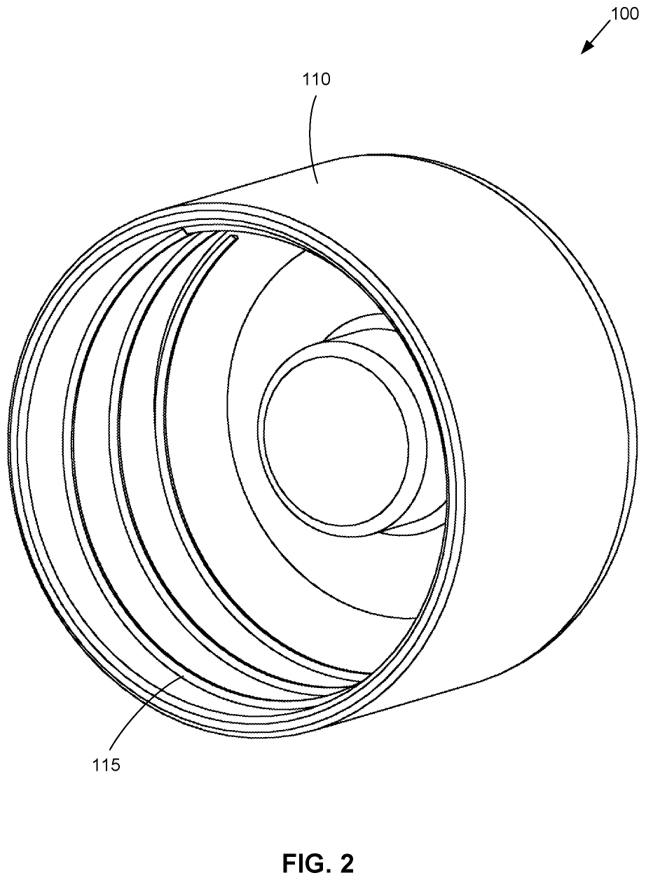

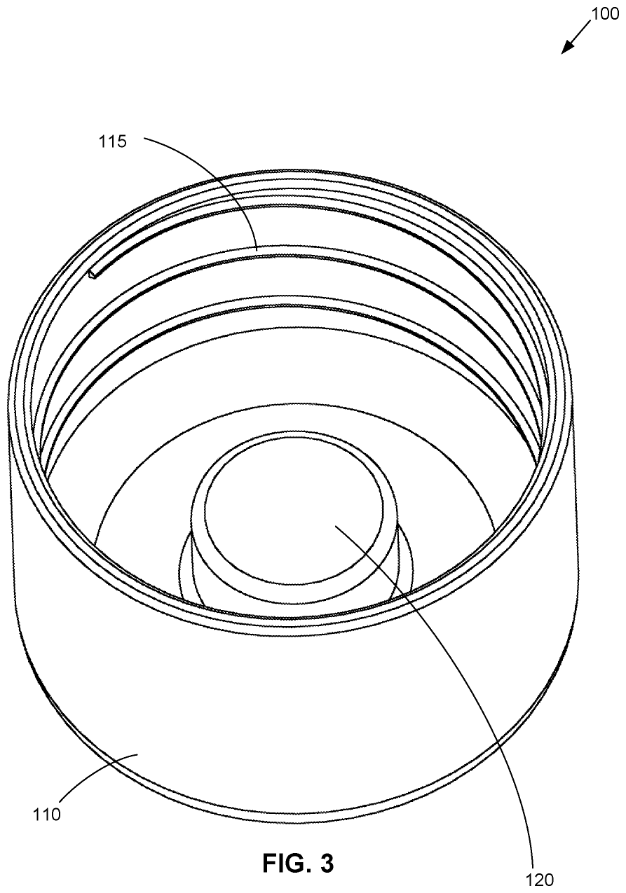

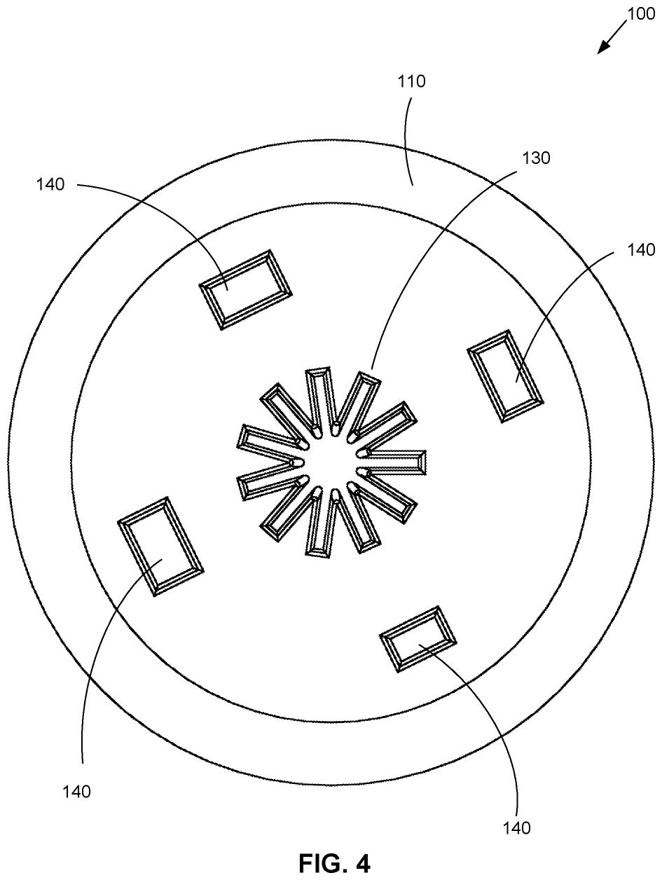

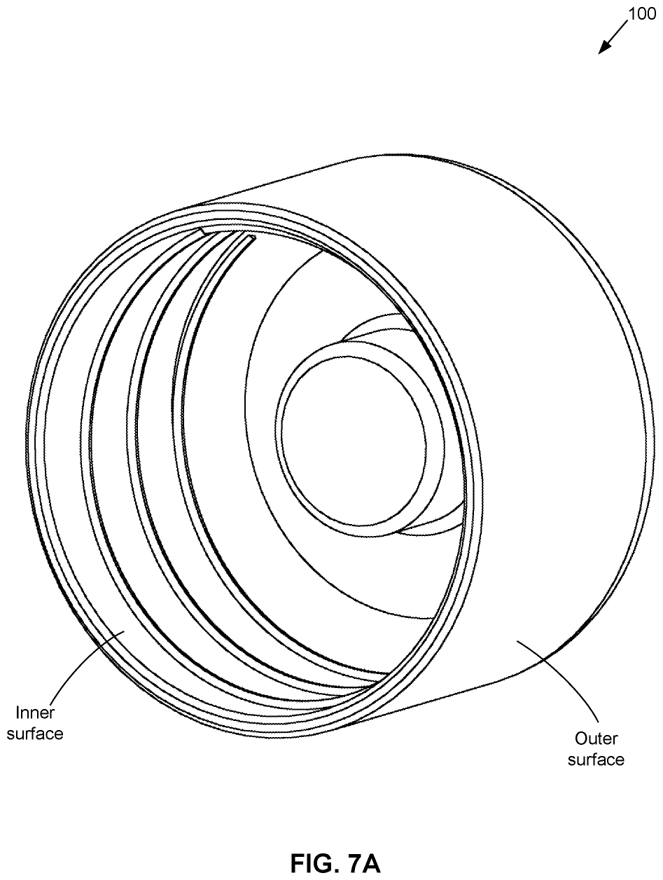

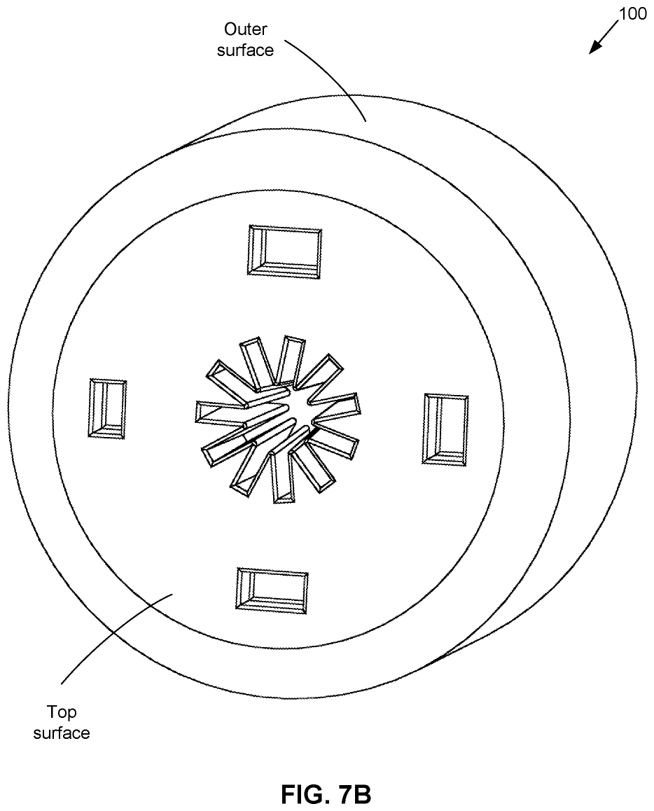

In an exemplary embodiment, with reference now to FIGS. 1 through 7B, an archery cap tool 100 is configured to function as a cap or lid for a storage unit, for example a tube for storing arrows. In various exemplary embodiments, archery cap tool 100 is compatible with archery storage tubes sold by manufacturers such as Legend Archery (Lewes, Del.), Easton Archery (Salt Lake City, Utah), October Mountain Products (Mount Joy, Pa.), Southland Archery Supply (California), and Gold Tip (Flora, Miss.). For example, archery cap tool 100 may be compatible with the Gold Tip brand EA Arrow Tube, the Legend Archery brand Telescoping Tube, the Easton brand Arrow Tote, and/or the like. In addition to functioning as a cap, archery cap tool 100 is configured with recesses that function as tools to perform basic archery functions.

In an exemplary embodiment, archery cap tool 100 comprises main body 110. Main body 110 may be constructed of any suitable durable material, such as metal, plastic, composite, or the like. In an exemplary embodiment, main body 110 comprises a thermoplastic polymer, for example acrylonitrile butadiene styrene (ABS). In another exemplary embodiment, main body 110 comprises 7075 aluminum formed from a single billet. Main body 110 may be monolithic; alternatively, main body 110 may comprise individual portions or elements coupled together, for example by welding. In an exemplary embodiment, main body 110 is formed via injection molding. Moreover, main body 110 may be constructed via rapid prototyping or other additive manufacturing processes. Main body 110 may be generally cylindrical, for example in order to serve as a cap for a cylindrical storage device; however, main body 110 is not limited in this regard and may be configured with different inner and/or outer shapes (for example, an inner cylindrical structure for threading onto a storage device, and an outer octagonal structure to facilitate grasping and/or twisting).

In various exemplary embodiments, main body 110 is configured with threads 115. Threads 115 may comprise any suitable configuration, pitch, height, depth, etc., in order to couple with a correspondingly threaded storage unit. In an exemplary embodiment, threads 115 are configured as a 1.5-13 mm thread structure. However, any suitable thread dimensions may be used, as desired.

In various exemplary embodiments, archery cap 100 further comprises inner boss 120 having broadhead wrench tool 130 disposed therein. Broadhead wrench tool 130 may be utilized to tighten or release a broadhead from an arrow shaft. It will be appreciated that the structures of main body 110 and inner boss 120 allow a user of archery cap 100 to keep their fingers well away from a broadhead while attaching or detaching from an arrow, thus reducing the likelihood of injury.

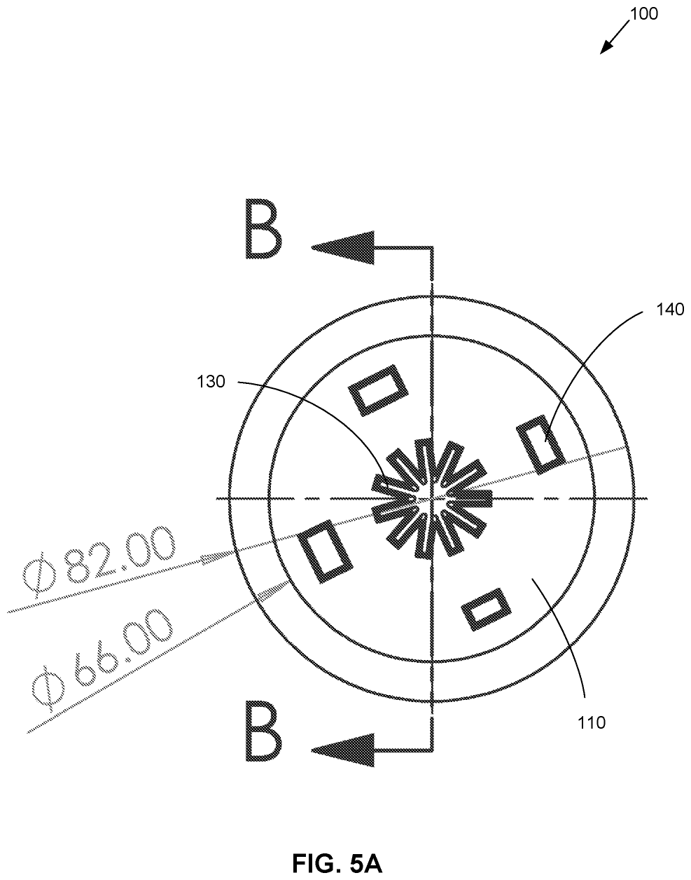

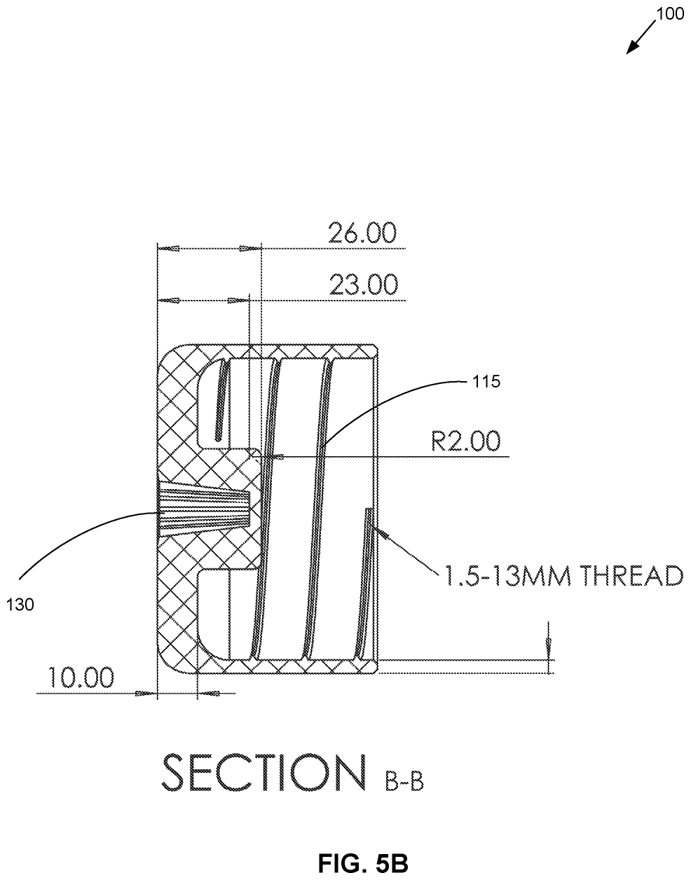

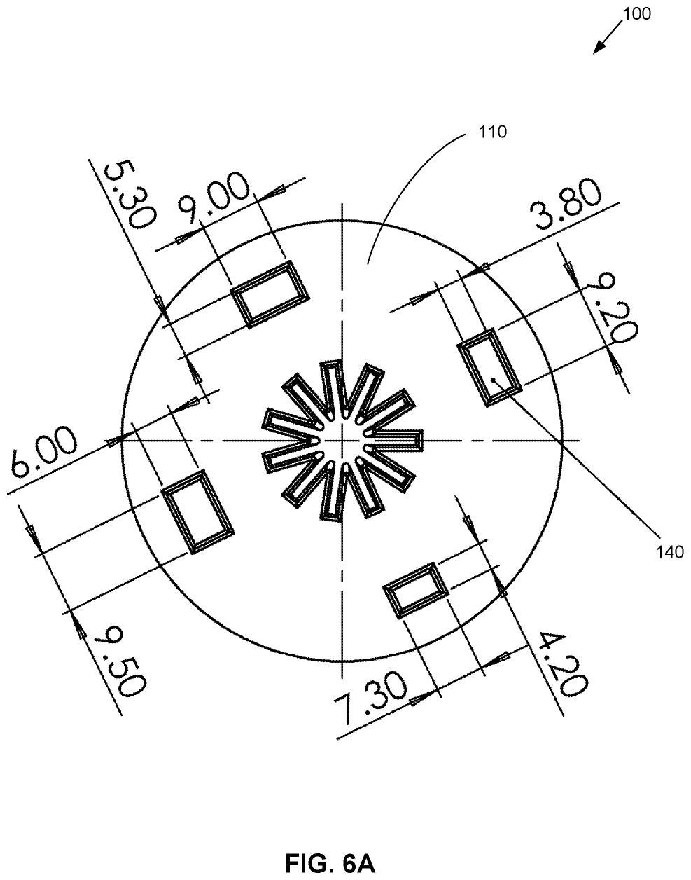

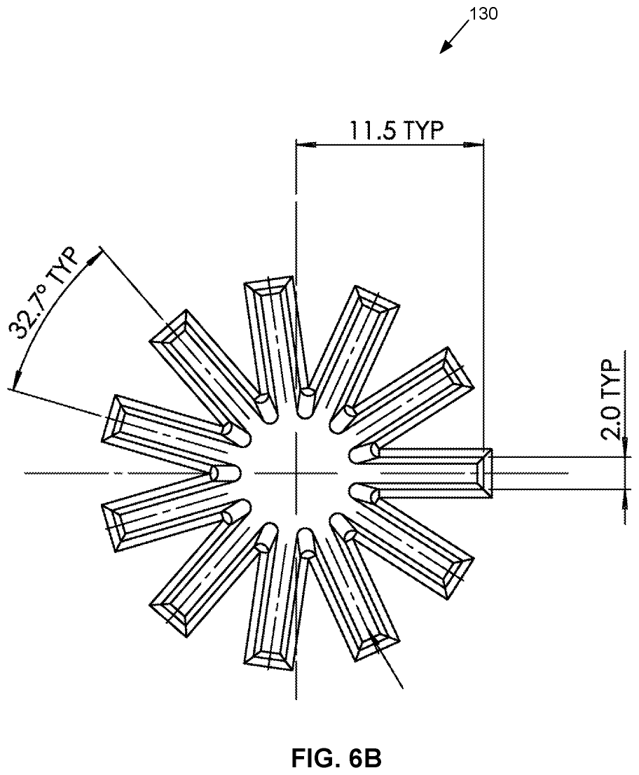

In an exemplary embodiment, broadhead wrench tool 130 comprises eleven flanges such that it is compatible with fixed blade broadheads, removable blade broadheads, and mechanical/expandable broadheads. However, broadhead wrench tool 130 is not limited in this regard and may be configured with more or fewer flanges, as desired, in order to accommodate a desired type or types of broadheads. With momentary reference to FIG. 6B, in various exemplary embodiments broadhead wrench tool 130 is configured with each flange having a length of about 11.5 mm from center, and each flange is spaced radially apart from each other flange by about 32.7 degrees center to center. Each flange may be sized as desired, for example with a width of about 2 mm. The flanges may be similar in size; alternatively, the flanges may differ in length, width, or depth from one another. In various embodiments, with momentary reference to FIG. 5B, broadhead wrench tool 130 is configured with a depth of about 23 mm. However, any suitable dimensions may be used, as desired.

In various exemplary embodiments, archery cap 100 further comprises one or more arrow nock tools 140 disposed therein. Archery cap 100 may comprise one arrow nock tool 140, two arrow nock tools 140, three arrow nock tools 140, four arrow nock tools 150, or more arrow nock tools 140. Arrow nock tools 140 may be evenly spaced on archery cap 100; alternatively, arrow nock tools may be grouped, placed, or spaced unevenly. In an exemplary embodiment, archery cap 100 comprises four arrow nock tools 140 disposed about 90 degrees apart around arrow cap tool 100. Arrow nock tool(s) 140 may be disposed on or in a common surface with broadhead wrench tool 130; alternatively, arrow nock tool(s) 140 may be disposed on different surface(s) of archery cap 100 than broadhead wrench tool 130.

Arrow nock tools 140 may be configured with a desired size or sizes in order to be used with adjustable nocks. In an exemplary embodiment, with momentary reference to FIG. 6A, archery cap 100 comprises a first arrow nock tool 140 having generally rectangular dimensions of about 3.8 mm by 9.2 mm, a second arrow nock tool 140 having dimensions of about 4.2 mm by 7.3 mm, a third arrow nock tool 140 having dimensions of about 6 mm by 9.5 mm, and a fourth arrow nock tool 140 having dimensions of about 5.3 mm by 9 mm. In various exemplary embodiments, each arrow nock tool 140 comprises a depth of about 7 mm, and more generally between about 6 mm and about 8 mm. However, shallower and/or deeper depths may be utilized, as desired.

In various exemplary embodiments, archery cap tool 100 may be interchangeable with existing caps for archery storage tubes, allowing a user to replace an existing cap and tool or tools (for example, a broadhead tool and a nock tool) with the multifunctional archery cap tool 100.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

In the foregoing specification, various embodiments have been described. However, one of ordinary skill in the art appreciates that various modifications and changes can be made without departing from the scope of the present disclosure as set forth in the claims below. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. An archery cap tool, comprising:
a main body comprising a durable material and having an inner surface, an outer surface, and a top surface;
a broadhead wrench tool formed in the main body and comprising an opening in the top surface; and
a plurality of nock tools formed in the main body in the top surface.

2. The archery cap tool of claim 1, wherein the plurality of nock tools comprise four nock tools.

3. The archery cap of claim 2, wherein the plurality of nock tools are equally radially spaced in the top surface.

4. The archery cap tool of claim 3, wherein each nock tool comprises a rectangular recess in the main body having an opening onto the top surface.

5. The archery cap tool of claim 4, wherein each nock tool is configured with different dimensions from each other nock tool.

6. The archery cap tool of claim 5, wherein each nock tool is configured with a depth of about 7 millimeters.

7. The archery cap tool of claim 1, wherein the broadhead wrench tool comprises a plurality of flanges, wherein the broadhead wrench tool is configured as a recess having a depth of about 23 millimeters, and wherein the broadhead wrench tool comprises an opening in the top surface.

8. The archery cap tool of claim 1, wherein the main body is configured with threads on the inner surface for coupling to an arrow storage container.

9. The archery cap tool of claim 1, wherein the main body comprises at least one of plastic, aluminum, or steel.

10. The archery cap tool of claim 1, wherein the outer surface is configured with a cylindrical shape.

11. The archery cap tool of claim 1, wherein the inner surface is configured with a cylindrical shape, and wherein the outer surface is configured with a non-cylindrical shape.

12. The archery cap tool of claim 1, wherein the top surface is flat.

13. The archery cap tool of claim 1, wherein the outer surface is textured to provide improved grip for a user.

14. A method, comprising:
forming an archery cap for coupling to an arrow storage container;
forming a broadhead tool in the archery cap to form an archery cap tool; and
forming a plurality of nock tools in the archery cap tool.

15. The method of claim 14, further comprising coupling the archery cap tool to an arrow storage container to retain arrows therein.

16. The method of claim 15, further comprising:
decoupling the archery cap tool from the arrow storage container; and
utilizing at least one of the broadhead tool or one of the plurality of nock tools to make an adjustment to an arrow.
